(19) United States
(12) Patent Application Publication
(10) Pub. No.: US 2012/0013094 A1
(43) Pub. Date: Jan. 19, 2012

(54) Illuminated Skateboard Deck

(76) Inventor: Askilya Golden-Justice, Los Angeles, CA (US)

(21) Appl. No.: 12/779,788

(22) Filed: Jul. 15, 2010

(51) Int. Cl. B62M 1/00

(52) U.S. Cl. 280/87.042

(57) ABSTRACT

A skateboard deck, with electro-luminescent wire (El Wire) tubing embedded inside the skateboard deck on top and bottom, with a power supply source embedded inside the skateboard deck on bottom.

### DETAILED DESCRIPTION OF INVENTION

The describe drawing figures illustrate the invention, an illuminated skateboard that is design to be ridden on a hard surface, such as a sidewalk or in the street.

As shown in FIG. 1. The top of the skateboard 1, which can be design in any shape, form or fashion, with a piece of ¾ to 1 inch hick of wood, plastic or metal. Standard screw holes 9, to add truck and wheels to skateboard. Embedded groove slots to place the electroluminescent wire into 6. Small holes so the electroluminescent wire can run through to the bottom side of the skateboard 13. The electroluminescent wire, which can be into pictures, lettering, line, abstract designs and shapes 7.

As shown in FIG. 2. Standard screw holes 9, to add trucks and wheels to skateboard. The electroluminescent wire coming through from the other side of the skateboard. Small hole so the electroluminescent wire can run through to the bottom side of the skateboard 13. The power supply underneath embedded in the skateboard. The bottom of the skateboard 2.

As shown in FIG. 3 is a side view of the illuminated skateboard Deck 4. On top and bottom of Skateboard deck is a coat of epoxy resin, covers over the embedded electroluminescent wire 8. Underneath embedded in the skateboard deck is the power supply and connection of the electroluminescent wire to the power supply, so you turn on or off the electroluminescent wire design to give it that illuminated skateboard look. The side view of the holes so you can mount truck and wheels to the skateboard.

### BACKGROUND OF INVENTION

1. Field of Invention

This invention relates generally to a skateboard, focusing more on a skateboard deck.

2. Description of Related Art

The following art shows or defines present state of this category:
Seifert-Nevarez, U.S. Pat. No. 6,431,733, shows a illuminated sport board with electro-luminescent sheet position top and bottom platform with a micro controlled power source mounted on top of the riding plat form. Covered in a clear resin.

Wood, U.S. Pat. No. 4,997,196, show an illuminated skateboard that put a string of LED light embedded in groove located on the perimeter of the skateboard. The LED's are controlled by a microcontroller mounted upon the bottom surface of the board.

The prior art form shows sport boards or skateboards that a embedded LED's on the side of skateboards and sheets of electro-luminescent laid out on top or bottom of sport board.

However, the prior art does not tech or show the construction of a skateboard that embeds many colors of electroluminescent wire in a skateboard deck that shows many different art designs that can be created. The present invention will show how it's done in the following summary.

### SUMMARY OF INVENTION

The present invention teaches the benefits in construction and use in which give rise to the objective described below.

The present invention is a illuminated skateboard deck. The illuminated skateboard deck is designed to be ridden on the street or sidewalk. It illuminates different colors of electroluminescent wire. Which is constructed by carving or routing out the design or art decoration display and embedding the electroluminescent wire in the skateboard deck on top and bottom. It is then covered over by a clear coat of epoxy flow resin on top riding platform surface of the board and bottom platform surface. The electroluminescent wire is then connected to a power battery supply speed driver, that has a self-contained battery compartment that hold 9 volt or AAA, an AA batteries. The power supply is embedded into the skateboard deck.

The Primary objective of the present invention is to provide an illuminated skateboard deck not taught by the prior art.

### BRIEF DESCRIPTION OF THE DRAWING

The Accompany drawing illustrated the present invention. In such drawing.

FIG. 1. Is the top perspective view of skateboard present invention .

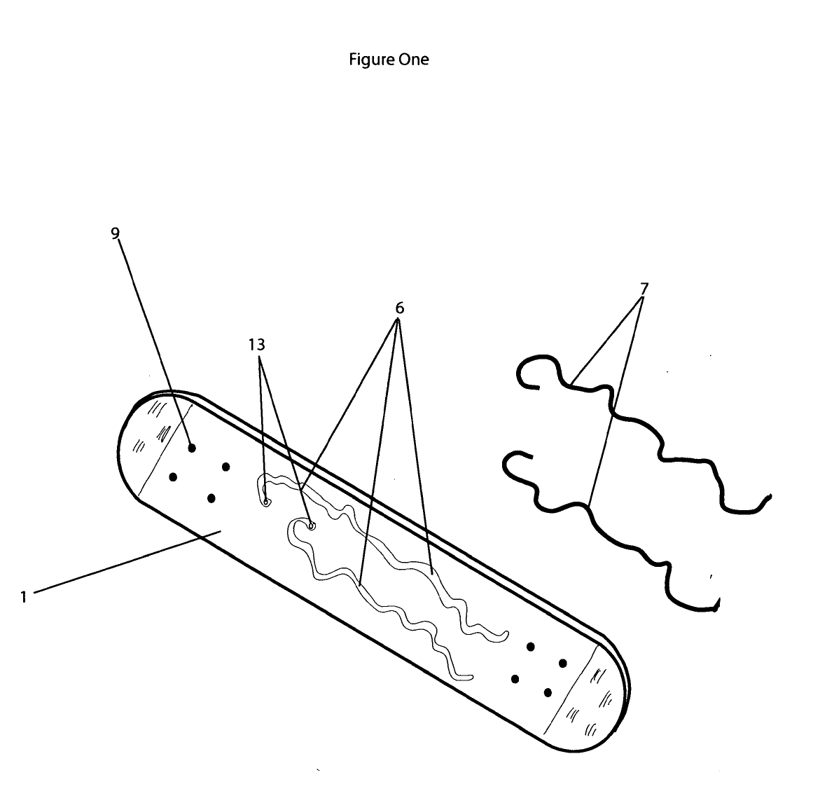

FIG. 2. Is the bottom perspective of skateboard present invention.

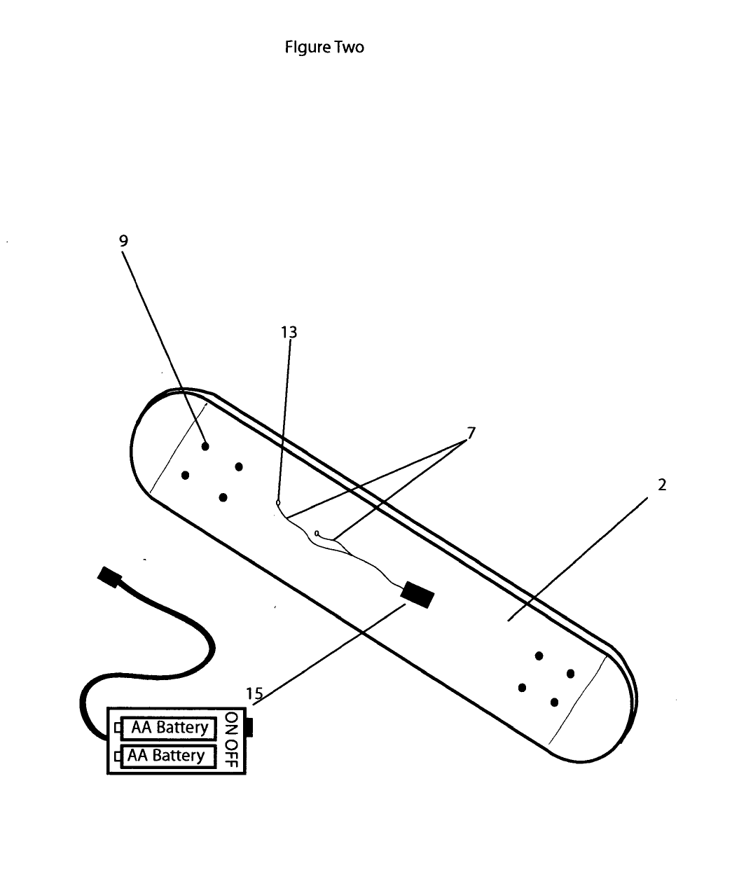

FIG. 3. Is side view of skateboard with supply unit and electro-luminescent wire embedded in skateboard.

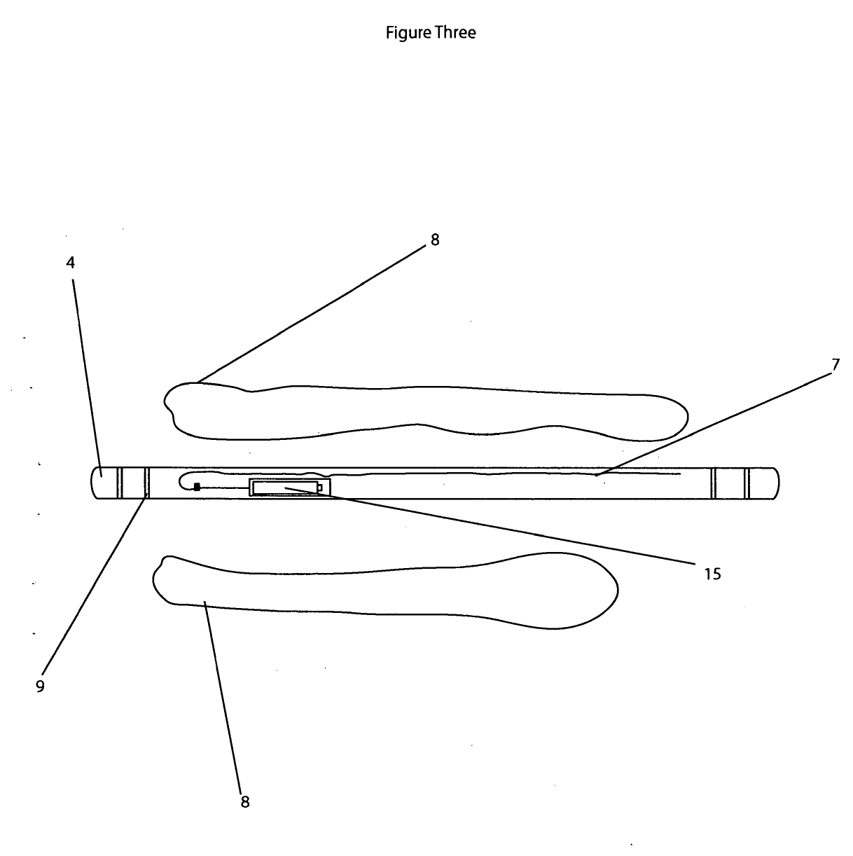

What is claimed is:

1. I am claiming the use of embedding different colors of electroluminescent wire (El Wire) in a skateboard decks on top and bottom, covered in clear resin.
